(19) United States
(12) Patent Application Publication
(10) Pub. No.: US 2023/0341043 A1
(43) Pub. Date: Oct. 26, 2023

(54) COST-EFFECTIVE ELECTRIC VEHICLE DRIVE UNIT COOLING AND LUBRICATION SYSTEM

(71) Applicants: Canoo Technologies Inc., Torrance, CA (US); Canoo Technologies Inc., Torrance, CA (US)

(72) Inventors: Charles Garmel, Torrance, CA (US); James Dameron, Torrance, CA (US); John Mason (deceased), (US); Yufei Zhu, Torrance, CA (US)

(21) Appl. No.: 17/660,329

(22) Filed: Apr. 22, 2022

(51) Int. Cl. F16H 57/04; H02K 9/19

(52) U.S. Cl. CPC F16H 57/0476; F16H 57/0435; F16H 57/0413; F16H 57/0417; F16H 57/0423; F16H 57/0457; H02K 9/19

(57) ABSTRACT

A lower sump is disposed at a bottom of a housing for an electric motor/stator and drive train of an electric vehicle. The lower sump is configured to accumulate coolant/lubricant fluid that has passed through windings of the electric motor/stator. The lower sump includes a portion configured to receive part of one or more drive gears for the drive train. An upper sump is disposed above the electric motor/stator and drive train and is configured to accumulate at least a portion of the fluid that has been moved by the drive gear(s). One or more electronically-controlled exit or entrance valves are configured to be positioned between the upper sump and one or more spaces adjacent to the windings. The one or more exit or entrance valves are configured to release the fluid from the upper sump to flow through the space(s) adjacent to the windings into the lower sump.

### TECHNICAL FIELD

This disclosure relates generally to cooling and lubricating electric vehicle drive systems. More specifically, this disclosure relates to improved cooling and lubrication of electric vehicle drive systems without requiring an electric fluid pump.

### BACKGROUND

Recent advances in electric motor and battery technologies have made electric vehicles (EVs) practical to manufacture. Electric vehicles have a number of advantages over conventional internal combustion vehicles, including the dramatically reduced footprint of the engine and/or drive train components. Traction electric motors in EV applications require cooling to function properly throughout the drive cycle and torque spectrum. The current state of the art of the EV industry is to combine an electric motor and transmission to share the same housing and coolant/lubricant.

### SUMMARY

This disclosure relates to improved cooling and lubrication of electric vehicle drive systems without requiring an electric fluid pump. It should be noted that this disclosure is of an apparatus and method intended for use with traction or auxiliary drives, but may also be scaled for main power units.

In one embodiment, a drive unit lubrication and cooling system includes a lower sump disposed at a bottom of a housing for an electric motor/stator and drive train of an electric vehicle. The lower sump is configured to accumulate coolant/lubricant fluid that has passed through windings of the electric motor/stator. The lower sump includes a portion configured to receive part of one or more drive gears for the drive train. The drive unit lubrication and cooling system also includes an upper sump disposed above the electric motor/stator and drive train. The upper sump is configured to accumulate at least a portion of the coolant/lubricant fluid that has been moved by the one or more drive gears. The drive unit lubrication and cooling system further includes one or more electronically-controlled exit or entrance valves configured to be positioned between the upper sump and one or more spaces adjacent to the windings of the electric motor/stator. The one or more electronically-controlled exit or entrance valves are configured to release the coolant/lubricant fluid from the upper sump to flow by gravity through the one or more spaces adjacent to the windings of the electric motor/stator into the lower sump.

In another embodiment, a method of lubricating and cooling a drive unit includes accumulating, in a lower sump disposed at a bottom of a housing for an electric motor/stator and drive train of an electric vehicle, coolant/lubricant fluid that has passed through windings of the electric motor/stator. The lower sump includes a portion receiving part of one or more drive gears for the drive train. The method also includes accumulating, in an upper sump disposed above the electric motor/stator and drive train, at least a portion of the coolant/lubricant fluid that has been moved by the one or more drive gears. The method further includes electronically controlling one or more exit or entrance valves between the upper sump and one or more spaces adjacent to the windings of the electric motor/stator to release the coolant/lubricant fluid from the upper sump to flow by gravity through the one or more spaces adjacent to the windings of the electric motor/stator into the lower sump.

For either embodiment, the one or more drive gears may move some of the coolant/lubricant fluid through one or more spaces between the housing and the one or more drive gears.

For either embodiment, a one-way check valve may be interposed between (i) the upper sump and (ii) the one or more spaces between the housing and the one or more drive gears. The one-way check valve may be configured to admit the coolant/lubricant fluid from the one or more spaces between the housing and the one or more drive gears into the upper sump and to inhibit return of the coolant/lubricant fluid from the upper sump into the one or more spaces between the housing and the one or more drive gears.

For either embodiment, a drive controller may be configured to control the one or more exit or entrance valves to selectively release the coolant/lubricant fluid accumulated in the upper sump into the one or more spaces adjacent to the windings of the electric motor/stator.

For either embodiment, the drive controller may be configured to control the one or more exit or entrance valves based on heat generation by the windings of the electric motor/stator.

For either embodiment, the drive controller may be configured to use signals from one or more temperature sensors disposed proximate to the windings of the electric motor/stator to control the one or more exit or entrance valves.

For either embodiment, the one or more spaces between the housing and the one or more drive gears may form part of a baffling system for movement of the coolant/lubricant fluid from the lower sump towards the upper sump.

For either embodiment, a heat exchanger may be fitted to the upper sump and may be configured to disperse heat from the coolant/lubricant fluid accumulated in the upper sump.

For either embodiment, movement of the coolant/lubricant fluid through one or more spaces between the housing and the one or more drive gears may lubricate multiple drive gears of the drive train including the one or more drive gears.

For either embodiment, no electric fluid motor may be required to move the coolant/lubricant fluid from the lower sump to the upper sump.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example electric vehicle (EV) within which cost-effective drive unit lubrication and cooling can be implemented in accordance with embodiments of the present disclosure;

FIGS. 2 and 2A illustrate an example vehicle control system for an EV within which cost-effective drive unit lubrication and cooling can be implemented in accordance with embodiments of the present disclosure;

FIG. 3 illustrates conceptually how cost-effective drive unit lubrication and cooling can be implemented in accordance with embodiments of the present disclosure;

FIG. 4 illustrates an example drive unit having a lower sump for use in cost-effective drive unit lubrication and cooling in accordance with embodiments of the present disclosure;

FIG. 5 illustrates an example upper sump for use in cost-effective drive unit lubrication and cooling in accordance with embodiments of the present disclosure; and

FIGS. 6A and 6B illustrate, with cut-away views of a drive train and electric motor, cost-effective drive unit lubrication and cooling in accordance with embodiments of the present disclosure.

### DETAILED DESCRIPTION

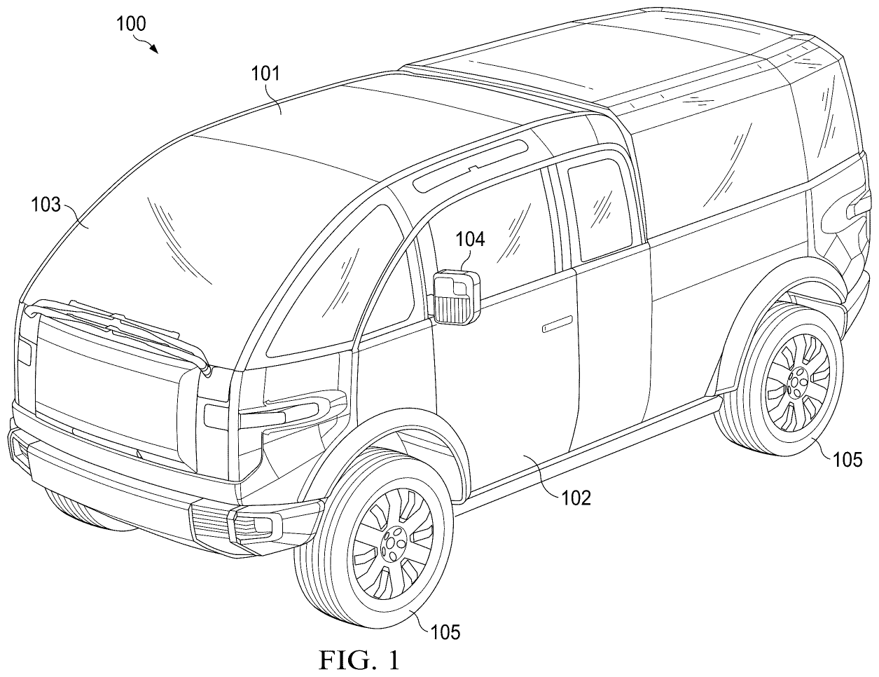

FIGS. 1 through 6B, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

In conventional combustion and electric vehicle designs, motors and reduction gear systems are typically installed in aluminum housings. Early drive unit designs used separate housing compartments with water cooling for a motor and gear oil to lubricate a transmission. Even with early EV designs, the electric motor was often cooled by a water jacket, which shares coolant with other vehicle components. This water jacket may wrap around the stator of an electric motor and cool the stator core by direct contact. One drawback to use of a water jacket is the increased packaging space and mass required to encompass the additional size of the water jacket around the electric motor.

In more recent EV designs, an electric motor is cooled using either a mechanical or electric pump to direct a combined coolant/lubricant fluid (such as automatic transmission fluid or “ATF”) over both the motor windings and the core of the stator for maximum heat rejection, while gears and bearings are lubricated by fluid splash. In some designs, the electric pump can be turned on/off to operate as a function of heat generation by the motor. That is, the electric pump operates when cooling is needed but turns off when no heat rejection required. This saves the power to operate the pump and leads to a more efficient system. Fluid splash lubrication of the gears and bearings continues during operation, regardless of whether the electric pump is on or off.

One approach to the drive units in such systems is to incorporate a “wet sump” design, where a volume of coolant/lubricant is located at a bottom of a drive unit and the electric pump draws fluid from this volume to cool the motor while the coolant/lubricant within the wet sump is agitated by rotating gears to splash fluid throughout the transmission. The efficiency of an integrated electric drive unit using a wet sump design is a function of the fluid fill level, instantaneous rotating component speed, and pump speed command.

FIG. 1 illustrates an example electric vehicle (EV) 100 within which cost-effective drive unit lubrication and cooling can be implemented in accordance with embodiments of the present disclosure. The embodiment of the vehicle 100 illustrated in FIG. 1 is for illustration and explanation only. FIG. 1 does not limit the scope of this disclosure to any particular implementation of a vehicle.

The vehicle 100 of FIG. 1 includes a chassis (not visible in FIG. 1) supporting a cabin 101 for carrying passengers. In some embodiments, the chassis of the vehicle 100 is in the form of a “skateboard” vehicle platform supporting one or more energy storage elements (such as batteries) that provide input electrical power used by various components of the EV, such as one or more electric motors of the electric vehicle 100 and a control system of the electric vehicle 100 described in further detail below.

Passengers may enter and exit the cabin 101 through at least one door 102 forming part of the cabin 101. A transparent windshield 103 and other transparent panels mounted within and forming part of the cabin 101 allow at least one passenger (referred to as the “operator,” even when the vehicle 100 is operating in an advanced driving or “AD” mode) to see outside the cabin 101. Rear-view mirrors 104 mounted to sides of the cabin 101 enable the operator to see objects to the sides and rear of the cabin 101 and may include warning indicators (such as selectively illuminated warning lights) for features such as blind spot warning (indicating that another vehicle is in the operator's blind spot) and/or lane departure warning.

Wheels 105 mounted on axles that are supported by the chassis and driven by the motor(s) via drive gears (all not visible in FIG. 1) allow the vehicle 100 to move smoothly. The wheels 105 are mounted on the axles in a manner permitting rotation relative to a longitudinal centerline of the vehicle 100 for steering and are also connected to steering controls (not visible). Conventional automobile features such as headlamps, taillights, turn signal indicators, windshield wipers, and bumpers are also depicted. The vehicle 100 may further include cargo storage within or connected to the cabin 101 and mounted on the chassis, and the cargo storage area(s) may optionally be partitioned by dividers from the passenger area(s) of the cabin 101.

Although FIG. 1 illustrates one example of an electric vehicle 100, those skilled in the art will recognize that the full structure and operation of a suitable vehicle are not depicted in the drawings or described here. Instead, for simplicity and clarity, only the structures and operations necessary for an understanding the present disclosure are depicted and described. Various changes may be made to the example of FIG. 1, and the cost-effective drive unit lubrication and cooling techniques described in this disclosure may be used with any other suitable vehicle.

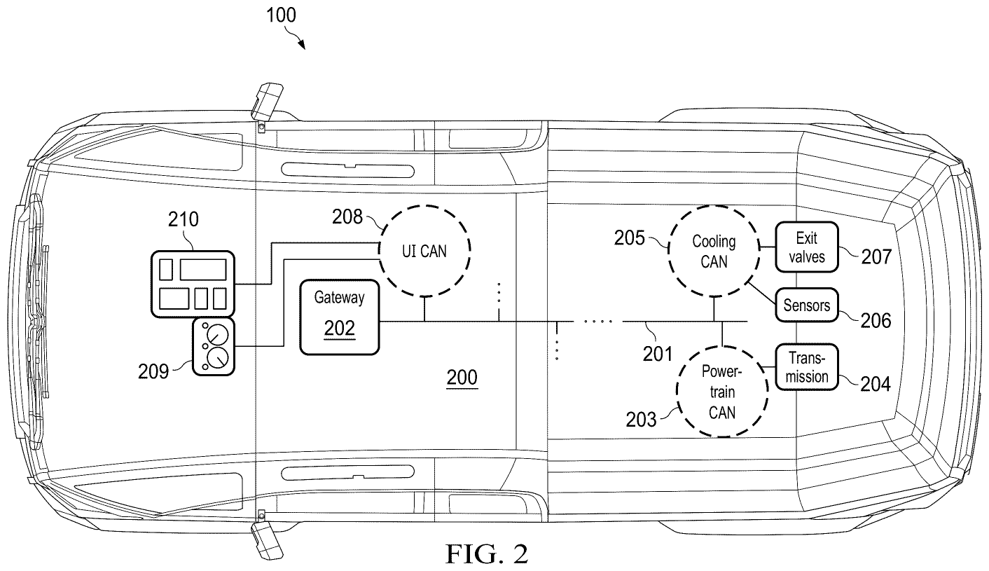

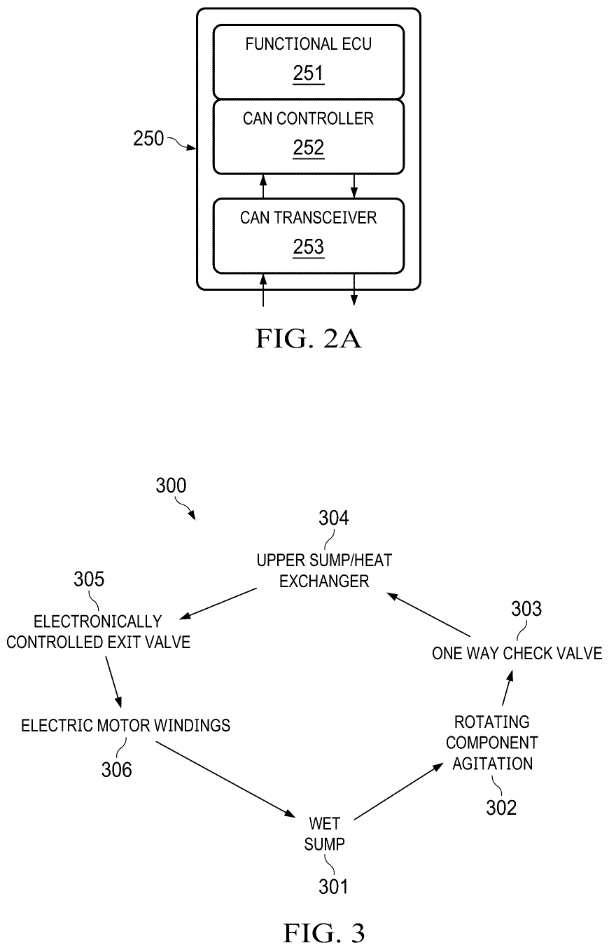

FIGS. 2 and 2A illustrate an example vehicle control system 200 for an EV within which cost-effective drive unit lubrication and cooling can be implemented in accordance with embodiments of the present disclosure. The embodiment of the vehicle control system 200 illustrated in FIGS. 2 and 2A is for illustration and explanation only. FIGS. 2 and 2A do not limit the scope of this disclosure to any particular implementation of a vehicle control system.

FIG. 2 depicts a modern vehicle control system 200 utilizing various electronic control units (ECUs) interconnected on a controller area network (CAN) via the so-called CAN bus. The standard for the CAN bus was released around 1993 by the International Organization for Standardization (ISO) as ISO 11898. The current version of that standard is ISO 11898-1:2015, and the CAN busses described herein may comply with that standard in some embodiments. Each ECU typically includes a printed circuit board (PCB) with a processor or microcontroller integrated circuit coupled to various input sensors, switches, relays, and other output devices. The CAN design permits the ECUs to communicate with each other without the need for a centralized host. Instead, communication takes place on a peer-to-peer basis. The CAN design therefore permits data from sensors and other ECUs to circulate around the vehicle ECUs, with each ECU transmitting sensor and programming information on the CAN bus while simultaneously listening to the CAN bus to pull out data needed to complete tasks being performed by that ECU. There is no central hub or routing system, just a continuous flow of information available to all the ECUs.

By way of example, power doors on a vehicle may be operated by an ECU called the body control module (not shown in FIG. 2). Sensors constantly report whether the doors are open or closed. When the driver pushes a button to close a door, the signal from that switch is broadcast across the CAN bus. When the body control module ECU detects that signal, however, the body control module ECU does not simply close the door. Instead, the body control module ECU first checks the data stream to make sure the vehicle is in park and not moving and, if all is well, gives a command to a power circuit that energizes the motors used to close the door. The body control module ECU may go even further, such as by monitoring the voltage consumed by the motors. If the body control module ECU detects a voltage spike, which happens when a door is hindered by an errant handbag or a wayward body part, the ECU immediately reverses the direction of the door to prevent potential injury. If the door closes properly, the latch electrically locks the door shut, which is an event that may be detected by the body control module ECU.

Notably, vehicle control systems are migrating to higher-speed networks with an Ethernet-like bus for which each ECU is assigned an Internet protocol (IP) address. Among other things, this may allow both centralized vehicle ECUs and remote computers to pass around huge amounts of information and participate in the Internet of Things (IoT).

In the example shown in FIG. 2, the vehicle control system 200 includes a CAN bus 201 embodied or controlled by a gateway ECU 202, which facilitates messages on and among CANs, transmitted and detected by ECUs. FIG. 2 illustrates a powertrain CAN 203 to which a transmission ECU 204 is connected and a cooling CAN 205 to which a sensors ECU 206 and an exit/entrance valves ECU 207 are connected. The sensors ECU 206 is connected to one or more temperature sensors (not shown) for determining the temperature of electric motor windings, while the exit/entrance valves ECU 207 is connected to electronically-controlled exit or entrance valves for an upper sump described in further detail below. The vehicle control system 200 in FIG. 2 also includes a user interface (UI) CAN 208 to which a “dashboard” ECU 209 and a touchscreen ECU 210 are connected. The ECUs 209 and 210 may be integrated with the respective dashboard controls and touchscreen. The UI CAN 208 and the associated dashboard ECU 209 and touchscreen 210 allow the operator to view indicators such as motor temperature. The dashboard ECU 209 may be connected to one or more sensors and one or more indicators other than those on the dashboard, such as the one or more temperature sensors described above.

FIG. 2A illustrates a high level block diagram for the architecture 250 of each CAN depicted in FIG. 2. Each CAN shown in FIG. 2, including the powertrain CAN 203 and cooling CAN 205, includes a functional ECU 251 for the specific function performed by the respective CAN (such as gear shift in the case of powertrain CAN 203). The functional ECU 251 is coupled to a CAN controller 252 that controls the interactions of the respective CAN with the other CANs within the vehicle 100 through the gateway ECU 202. A CAN transceiver 253 receives messages from and transmit messages to other CANs under the control of the CAN controller 252. To support various functions such as motor cooling and drive train lubrication, the powertrain CAN 203 for the vehicle 100 can control the transmission of the vehicle 100 to engage and disengage gears driving the axles from the motor, and the cooling CAN 205 for the vehicle 100 controls one or more exit or entrance valves.

Although FIGS. 2 and 2A illustrate one example of a vehicle control system 200 for an EV within which cost-effective drive unit lubrication and cooling can be implemented, those skilled in the art will recognize that the full structure and operation of a suitable vehicle control system is not depicted in the drawings or described here. Instead, for simplicity and clarity, only the structures and operations necessary for an understanding the present disclosure are depicted and described. Various changes may be made to the example of FIGS. 2 and 2A, and the cost-effective drive unit lubrication and cooling techniques described in this disclosure may be used with any other suitable vehicle control system.

FIG. 3 illustrates conceptually how cost-effective drive unit lubrication and cooling can be implemented in accordance with embodiments of the present disclosure. As shown in FIG. 3, a drive unit lubrication and cooling system 300 includes a wet sump 301, such as of the type mentioned above. One or more rotating components 302 within the drive unit agitate coolant/lubricant fluid within the wet sump 301 for splash lubrication of one or more drive gears. A one-way check valve 303 admits agitated coolant/lubricant fluid into an upper sump 304 while preventing the coolant/lubricant fluid accumulated in the upper sump 304 from flowing back into the wet sump 301. The upper sump 304 may include a heat exchanger for dissipating heat from the coolant/lubricant fluid accumulated in the upper sump 304. One or more electronically-controlled exit or entrance valves 305 selectively release coolant/lubricant fluid from the upper sump 304 to cool electric motor/stator windings 306. The coolant/lubricant fluid can trickle or otherwise flow by gravity back down to the wet sump 301.

In the design illustrated in FIG. 3, an electric fluid pump associated with conventional use of a wet sump is removed from the drive unit assembly and replaced by the combination of the upper sump 304, the one-way check valve 303, and the one or more exit or entrance valves 305. The motor is designed for use with an upper sump system from which coolant/lubricant fluid is gravity-fed to the electric motor/stator windings. This design for the system 300 uses one or more existing rotating components 302, combined with a fluid directing or baffling system, to feed the upper sump 304. The one-way check valve 303 may be positioned at the inlet to the upper sump 304 and allows coolant/lubricant fluid to only flow into the upper sump 304 from the transmission side of the drive unit. The one or more electronically-controlled exit or entrance valves 305 are tuned, similar to the electric fluid pump of conventional designs, to allow different flow rates of coolant/lubricant fluid over the motor for different drive cycles or cooling conditions, maximizing coolant/lubricant fluid volume and potential energy in the upper sump 304. The upper sump 304 may incorporate a heat exchanging element to cool the volume of coolant/lubricant fluid prior to release over the electric motor/stator windings 306.

Although FIG. 3 illustrates one example of conceptually how cost-effective drive unit lubrication and cooling can be implemented, various changes may be made to FIG. 3. For example, the drive unit lubrication and cooling system 300 may include any suitable number of each component shown in FIG. 3.

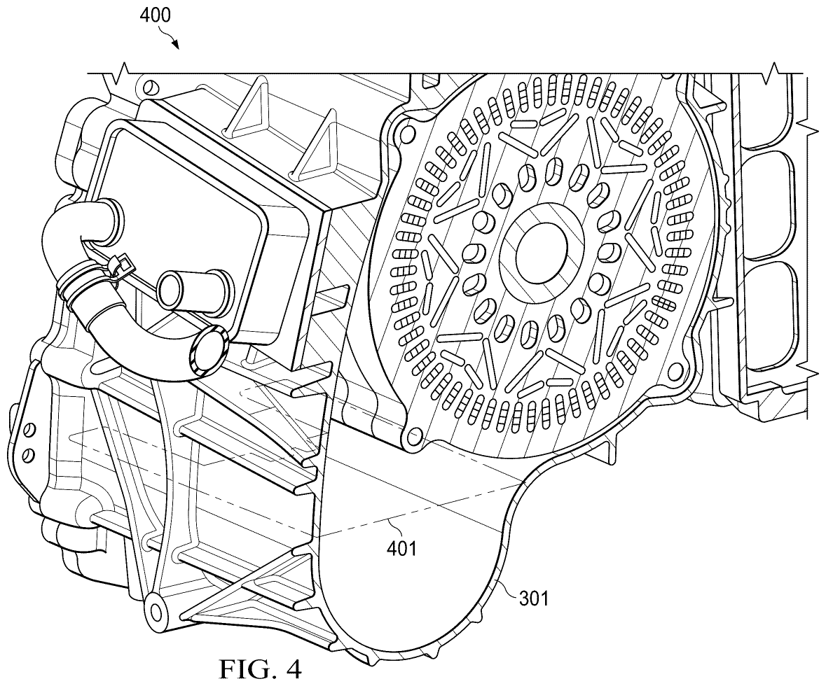

FIG. 4 illustrates an example drive unit 400 having a lower sump 301 for use in cost-effective drive unit lubrication and cooling in accordance with embodiments of the present disclosure. As shown in FIG. 4, the lower (wet) sump 301 is a volume cavity in the housing for the drive unit 400, which can be located below the electric motor and gearbox and gravity-fed with coolant/lubricant fluid used to cool the motor windings and lubricate transmission components. An example of a coolant/lubricant fluid level 401 in the drive unit 400 is indicated in FIG. 4.

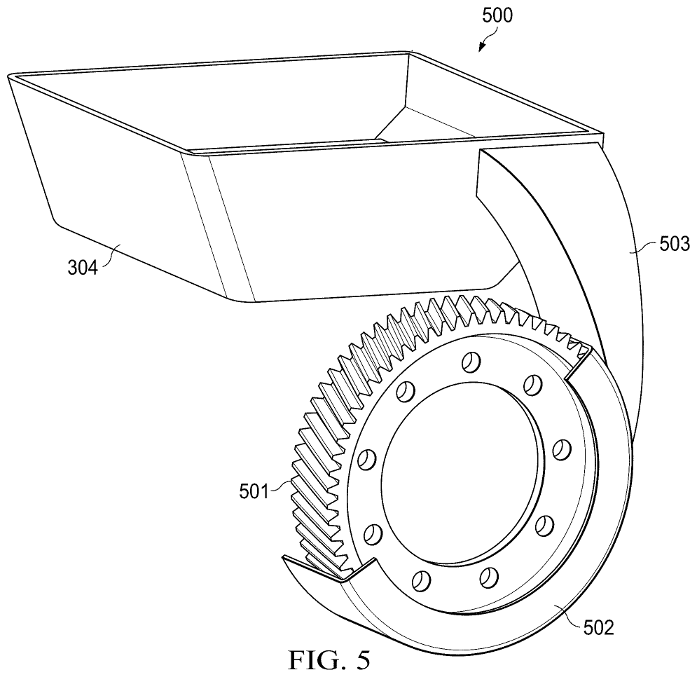

FIG. 5 illustrates an example upper sump 500 for use in cost-effective drive unit lubrication and cooling in accordance with embodiments of the present disclosure. As shown in FIG. 5, the upper sump 304 is a volume cavity in the housing above the electric motor and gearbox, which uses directed gravity feed ports (non-pressurized) to cool the motor and transmission components. During operation, the upper sump 304 accumulates coolant/lubricant fluid from the drive train.

One or more drive gears 501 are closely encased by a housing 502, where coolant/lubricant fluid between the drive gear(s) 501 and the housing 502 is agitated by rotation of the drive gear(s) 501. The rotation and agitation result in splash lubrication of the drive gear(s) 501 and also coolant/lubricant fluid flowing into a baffling system 503. The baffling system 503 conducts the coolant/lubricant fluid toward the upper sump 304, where the one-way check valve 303 admits the coolant/lubricant fluid from the baffling system 503 into the upper sump 304 while preventing return flow from the upper sump 304 into the baffling system 503. The agitation and baffling system thus replaces an electric fluid pump in moving coolant/lubricant fluid from the lower sump 301 into the upper sump 304.

Pressurized cooling using an electric fluid pump has the capacity to adjust flow rate by altering pump speed/pressure, thus correlating coolant/lubricant fluid flow with the motor heat generation. The power output of an electric machine is dependent on the ability to remove heat from the motor, so more effective heat removal results in higher continuous motor output power. Typically, pressurized oil cooling results in good heat removal. However, pressurized cooling requires additional components to pressurize and pump the fluid throughout the motor, such as through the use of a heat exchanger, oil filter and an electric fluid pump, which adds to weight and production cost. By contrast, systems that feed coolant/lubricant by gravity over electric motors, as described for the present disclosure, have the potential for somewhat limited functionality from a cooling standpoint, being constrained to feeding non-pressurized coolant/lubricant fluid at flow rates defined by the orifice passageway sizes and (in previous designs) having no correlation over real-time motor actual heat generation/removal requirement. Thus, prior designs for gravity fed cooling are considered slightly less effective than pressurized cooling. The following describes how the drive unit lubrication and cooling system 300 may be designed to overcome these types of issues.

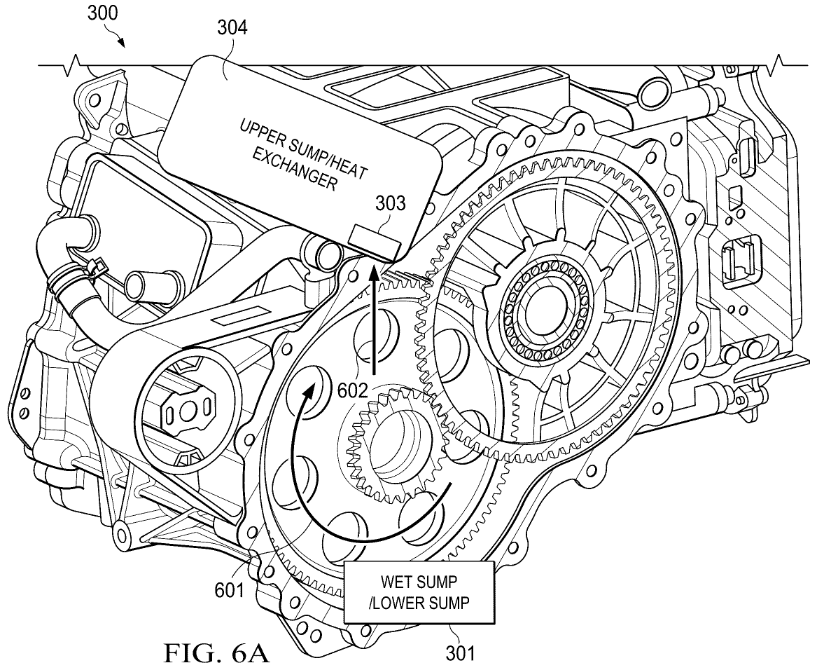

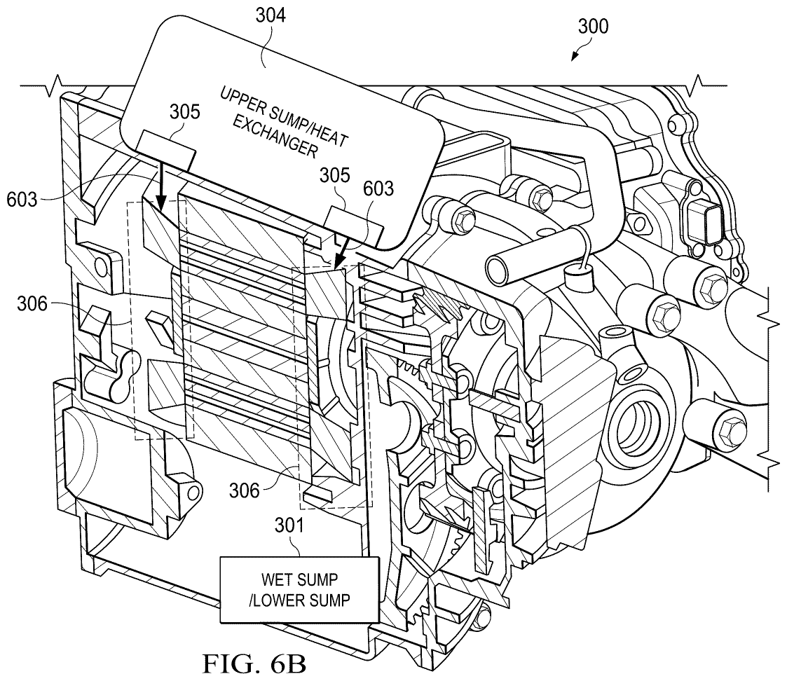

FIGS. 6A and 6B illustrate, with cut-away views of a drive train and electric motor, cost-effective drive unit lubrication and cooling in accordance with embodiments of the present disclosure. As shown in FIGS. 6A and 6B, the drive unit lubrication and cooling system 300 includes is shown in relation to the drive train and electric motor of a vehicle (such the vehicle 100). More specifically, FIG. 6A depicts an electric motor and drive train with longitudinal cutaway, and FIG. 6B depicts the same electric motor and drive train of FIG. 6A with transverse cutaway. The embodiment of the drive unit lubrication and cooling system 300 illustrated in FIGS. 6A and 6B is for illustration and explanation only. FIGS. 6A and 6B do not limit the scope of this disclosure to any particular implementation of a drive unit lubrication and cooling system.

In the drive unit lubrication and cooling system 300, the upper sump 304 accumulates coolant/lubricant fluid. Rotation 601 of one or more drive gears shown in FIG. 6A agitates the coolant/lubricant fluid within the lower sump 301, moving some of that coolant/lubricant fluid out of the lower sump 301 into one or more regions between the drive gear(s) and the adjacent portion(s) of the housing. As a result of movement by the drive gear(s), some coolant/lubricant fluid is moved through a path 602 as shown in FIG. 6A into a baffling system and passes through the one-way check valve 303 into the upper sump 304.

Under control of the drive unit controller for the drive unit lubrication and cooling system 300, as needed for cooling, the coolant/lubricant fluid accumulated in the upper sump 304 is released by electronically controlling the one or more exit or entrance valves 305 to flow by gravity down through the electric motor/stator windings 306. This is shown as one or more paths 603 in FIG. 6B. After flowing through the electric motor/stator windings 306, the coolant/lubricant fluid is accumulated once again in the lower sump 301.

With the approach of the present disclosure, the electric drive unit uses the combination of splash lubrication and the upper sump 304 to cool a motor and gearbox, removing the need for an electric fluid pump. This approach can improve overall drive unit efficiency, as there is no power draw for an electric or mechanical fluid pump, and reduce the cost of implementation by eliminating the electric fluid pump. The drive unit controller in the powertrain CAN 203 can determine when to provide cooling to motor end windings based on heat generation and, by controlling the electronically-controlled exit or entrance valve(s) 305, allow correlation of coolant/lubricant fluid flow with the motor heat generation.

Although FIGS. 6A and 6B illustrate, with cut-away views of a drive train and electric motor, one example of cost-effective drive unit lubrication and cooling, various changes may be made to FIGS. 6A and 6B. For example, the drive unit lubrication and cooling system 300 may include any suitable number of each component shown in FIGS. 6A and 6B.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A drive unit lubrication and cooling system comprising:
a lower sump disposed at a bottom of a housing for an electric motor/stator and drive train of an electric vehicle, the lower sump configured to accumulate coolant/lubricant fluid that has passed through windings of the electric motor/stator, the lower sump including a portion configured to receive part of one or more drive gears for the drive train;
an upper sump disposed above the electric motor/stator and drive train, the upper sump configured to accumulate at least a portion of the coolant/lubricant fluid that has been moved by the one or more drive gears; and
one or more electronically-controlled exit valves each positioned at an exit for the upper sump into one or more spaces adjacent to the windings of the electric motor/stator, the one or more electronically-controlled exit valves configured to selectively release the coolant/lubricant fluid accumulated in the upper sump into the one or more spaces adjacent to the windings of the electric motor/stator, to flow by gravity through the one or more spaces adjacent to the windings of the electric motor/stator into the lower sump.

2. The drive unit lubrication and cooling system according to claim 1, wherein the one or more drive gears are configured to move some of the coolant/lubricant fluid through one or more spaces between the housing and the one or more drive gears.

3. The drive unit lubrication and cooling system according to claim 2, further comprising:
a one-way check valve interposed between (i) the upper sump and (ii) the one or more spaces between the housing and the one or more drive gears, the one-way check valve configured to admit the coolant/lubricant fluid from the one or more spaces between the housing and the one or more drive gears into the upper sump and to inhibit return of the coolant/lubricant fluid from the upper sump into the one or more spaces between the housing and the one or more drive gears.

4. The drive unit lubrication and cooling system according to claim 2, further comprising:
a drive controller configured to control the one or more electronically-controlled exit valves.

5. The drive unit lubrication and cooling system according to claim 4, wherein the drive controller is configured to control the one or more electronically-controlled exit valves based on heat generation by the windings of the electric motor/stator.

6. The drive unit lubrication and cooling system according to claim 5, wherein the drive controller is configured to use signals from one or more temperature sensors disposed proximate to the windings of the electric motor/stator to control the one or more electronically-controlled exit valves.

7. The drive unit lubrication and cooling system according to claim 2, wherein the one or more spaces between the housing and the one or more drive gears form part of a baffling system for movement of the coolant/lubricant fluid from the lower sump towards the upper sump.

8. The drive unit lubrication and cooling system according to claim 1, further comprising:
a heat exchanger fitted to the upper sump and configured to disperse heat from the coolant/lubricant fluid accumulated in the upper sump.

9. The drive unit lubrication and cooling system according to claim 1, wherein the drive unit lubrication and cooling system is configured such that movement of the coolant/lubricant fluid through one or more spaces between the housing and the one or more drive gears lubricates multiple drive gears of the drive train including the one or more drive gears.

10. The drive unit lubrication and cooling system according to claim 1, wherein the drive unit lubrication and cooling system is configured such that no electric fluid motor is required to move the coolant/lubricant fluid from the lower sump to the upper sump.

11. A method of lubricating and cooling a drive unit, the method comprising:
accumulating, in a lower sump disposed at a bottom of a housing for an electric motor/stator and drive train of an electric vehicle, coolant/lubricant fluid that has passed through windings of the electric motor/stator, the lower sump including a portion receiving part of one or more drive gears for the drive train;
accumulating, in an upper sump disposed above the electric motor/stator and drive train, at least a portion of the coolant/lubricant fluid that has been moved by the one or more drive gears; and
electronically controlling one or more exit valves each positioned at an exit for the upper sump into one or more spaces adjacent to the windings of the electric motor/stator to selectively release the coolant/lubricant fluid accumulated in the upper sump into the one or more spaces adjacent to the windings of the electric motor/stator, to flow by gravity through the one or more spaces adjacent to the windings of the electric motor/stator into the lower sump.

12. The method according to claim 11, wherein the one or more drive gears move some of the coolant/lubricant fluid through one or more spaces between the housing and the one or more drive gears.

13. The method according to claim 12, further comprising:
using a one-way check valve interposed between (i) the upper sump and (ii) the one or more spaces between the housing and the one or more drive gears, admitting the coolant/lubricant fluid from the one or more spaces between the housing and the one or more drive gears into the upper sump and inhibiting return of the coolant/lubricant fluid from the upper sump into the one or more spaces between the housing and the one or more drive gears.

14. The method according to claim 12, further comprising:
controlling the one or more exit valves with a drive controller.

15. The method according to claim 14, wherein the one or more exit valves are controlled based on heat generation by the windings of the electric motor/stator.

16. The method according to claim 15, further comprising:
using signals from one or more temperature sensors disposed proximate to the windings of the electric motor/stator to control the one or more exit valves.

17. The method according to claim 12, wherein the one or more spaces between the housing and the one or more drive gears form part of a baffling system for movement of the coolant/lubricant fluid from the lower sump towards the upper sump.

18. The method according to claim 11, further comprising:
dispersing heat from the coolant/lubricant fluid accumulated in the upper sump using a heat exchanger fitted to the upper sump.

19. The method according to claim 11, wherein movement of the coolant/lubricant fluid through one or more spaces between the housing and the one or more drive gears lubricates multiple drive gears of the drive train including the one or more drive gears.

20. The method according to claim 11, wherein no electric fluid motor is required to move the coolant/lubricant fluid from the lower sump to the upper sump.
